(19) United States
(12) Patent Application Publication
(10) Pub. No.: US 2023/0249211 A1
(43) Pub. Date: Aug. 10, 2023

(54) FOLDING WAND WITH FLUID CONDUIT PASSING THROUGH AXIS OF ROTATION

(71) Applicant: GOJO Industries, Inc., Akron, OH (US)

(72) Inventors: Mark E. Rosenkranz, Akron, OH (US); Christopher Mann, Akron, OH (US)

(21) Appl. No.: 18/165,885

(22) Filed: Feb. 7, 2023

Related U.S. Application Data
(60) Provisional application No. 63/307,613, filed on Feb. 7, 2022.

(51) Int. Cl. B05B 15/652; B05B 9/01

(52) U.S. Cl. CPC B05B 15/652; B05B 9/01

(57) ABSTRACT

An applicator for dispensing a fluid includes a housing and a pump disposed within the housing. A wand extends in a first direction between a first end and a second end. The wand is rotatably coupled to the housing between an open position and a closed position. A conduit extends from the pump to the first end of the wand such that the fluid flows in the first direction to be dispensed from the second end of the wand. The wand defines an aperture through which the conduit enters the first end of the wand such that the conduit extends in a second direction non-parallel to the first direction to enter the first end. The conduit remains in the aperture regardless of the position of the wand.

### CROSS REFERENCE TO RELATED APPLICATIONS

This application is a divisional of and claims priority to U.S. Provisional Patent Application No. 63/307,613, filed on Feb. 7, 2022, entitled “FOLDING WAND WITH FLUID CONDUIT PASSING THROUGH AXIS OF ROTATION” which is hereby incorporated by reference herein.

### TECHNICAL FIELD

The present invention relates to an applicator, and more particularly to an applicator with a collapsible wand and a rotatable nozzle for dispensing ready-to-use liquid or fluid products, such as sanitizers or disinfectants.

### BACKGROUND

There are many known applicators for dispensing products (e.g., liquids or fluids) to maintain lawns, gardens, plants, sanitizers, or disinfectants. Some applicators include a wand that is rotatably attached to a housing. Often, a conduit is provided between a reservoir and the wand to deliver the product from the reservoir to the wand. Such applicators tend to result in undesired twisting and/or kinking of the conduit when the wand is rotated.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In accordance with an aspect, an applicator for dispensing a fluid includes a housing and a pump disposed within the housing. The applicator also includes a wand extending in a first direction between a first end and a second end. The wand is rotatably coupled to the housing between an open position and a closed position regardless of whether the wand is in the open position, the closed position, or between the open position and the closed position. A conduit extends from the pump to the first end of the wand such that the fluid flows in the first direction en-route to being dispensed from the second end of the wand. The wand defines an aperture through which the conduit enters the first end of the wand such that the conduit extends in a second direction non-parallel to the first direction to enter the first end. The conduit remains in the aperture when the wand is in the open position, the closed position, and between the open position and the closed position.

In accordance with an aspect, an applicator for dispensing a fluid includes a housing and a pump disposed within the housing. The applicator also includes a wand extending in a first direction between a first end and a second end. The wand is rotatably coupled to the housing between an open position and a closed position, the wand defining a duct extending between the first end and the second end. The wand includes a curved surface located at the first end, the curved surface defining an aperture. A conduit extends from the pump to the first end of the wand such that the fluid flows in the first direction en-route to being dispensed from the second end of the wand. The conduit includes a first portion disposed in the housing, a second portion disposed in the curved surface, and a third portion disposed in the duct. The conduit passes through the aperture to enter the first end of the wand such that the conduit extends in a second direction non-parallel to the first direction to enter the first end of the wand. The wand is rotatable from a first position relative to the housing to a second position relative to the housing. When the wand is in the first position, a conduit path of the conduit from the first portion to the third portion has a first length. When the wand is in the second position, the conduit path from the first portion to the third portion has a second length, and the first length is equal to the second length.

In accordance with an aspect, an applicator for dispensing a fluid includes a housing and a pump disposed within the housing. The applicator also includes a wand extending in a first direction between a first end and a second end. The wand is rotatably coupled to the housing between an open position and a closed position. The wand defines a duct extending between the first end and the second end. The wand includes a curved surface located at the first end, the curved surface defining an aperture. The wand defines a conduit extending from the pump to the first end of the wand such that the fluid flows in the first direction en-route to being dispensed from the second end of the wand. The conduit includes a first portion disposed in the housing, a second portion disposed in the curved surface, and a third portion disposed in the duct. The conduit passes through the aperture to enter the first end of the wand such that the conduit extends in a second direction non-parallel to the first direction to enter the first end of the wand. The wand is rotatable from a first position relative to the housing to a second position relative to the housing. The second portion of the conduit rotates about a conduit central axis as the wand is rotated from a first position relative to the housing to a second position relative to the housing.

The following description and annexed drawings set forth certain illustrative aspects and implementations. These are indicative of but a few of the various ways in which one or more aspects can be employed. Other aspects, advantages, and/or novel features of the disclosure will become apparent from the following detailed description when considered in conjunction with the annexed drawings.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example applicator in a holster associated with a fluid reservoir;

FIG. 2 illustrates an example applicator with a foldable wand in a closed position;

FIG. 3 illustrates an example applicator with the foldable wand in an open position;

FIG. 4 illustrates an example applicator with the foldable wand in an intermediate position;

FIG. 5 illustrates an example applicator with a cover removed;

FIG. 6 illustrates an example applicator in a partially exploded view;

FIG. 7 shows a partial detail of the applicator;

FIG. 8 shows a detail view of a knuckle of the applicator;

FIG. 9 shows a detail view of the knuckle and a conduit of the applicator;

FIG. 10 is a detail view of a portion of a carriage of the applicator;

FIG. 11 is another detail view of a portion of a carriage of the applicator;

FIG. 12 is a detail view of the conduit, carriage, and knuckle with the wand in a closed position;

FIG. 13 is a detail view of the conduit, carriage, and knuckle with the wand in an open position;

FIG. 14 is a perspective view of a switch and a switch arm;

FIG. 15 is a perspective partial cross-section view of a valve and a pump within the housing;

FIG. 16 is a perspective detail view of a portion of the housing; and

FIG. 17 is a partially exploded view of the applicator.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It is evident, however, that the claimed subject matter can be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

Certain terminology is used herein for convenience only and is not to be taken as a limitation on the disclosed subject matter. Relative language used herein is best understood with reference to the drawings, in which like numerals are used to identify like or similar items. Further, in the drawings, certain features may be shown in somewhat schematic form.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

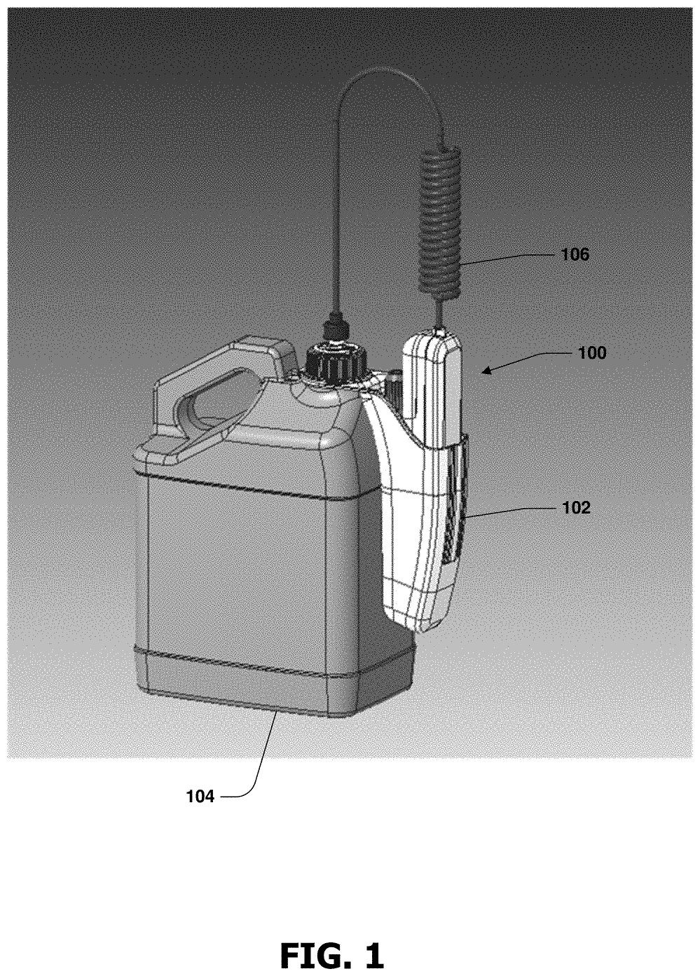

Referring to FIG. 1, an example applicator 100 shown in a holster 102 associated with a fluid reservoir 104 is illustrated. In accordance with several aspects, the present disclosure provides the applicator 100 for dispensing a product (e.g., a liquid or fluid). The fluid can include any number of suitable fluids and can include, but is not limited to, surface disinfectant, soap, sanitizer, etc. As used throughout this description, the terms “applicator,” “sprayer,” or other like terms are used herein interchangeably to illustrate a simplified view of an exemplary applicator 100.

It sis to be appreciated that the shown example fluid reservoir 104 is merely an example, and any suitable fluid container can be used as the fluid reservoir 104 with the present disclosure. The applicator 100 can be in fluid communication with an interior volume of the fluid reservoir 104 through a first conduit 106, or the like.

The present disclosure is meant to encompass a structure adapted to discharge, dispense, project, spray, etc., any number of liquids and additional applicator 100 components. In some embodiments, the applicator can include additional elements that are not depicted.

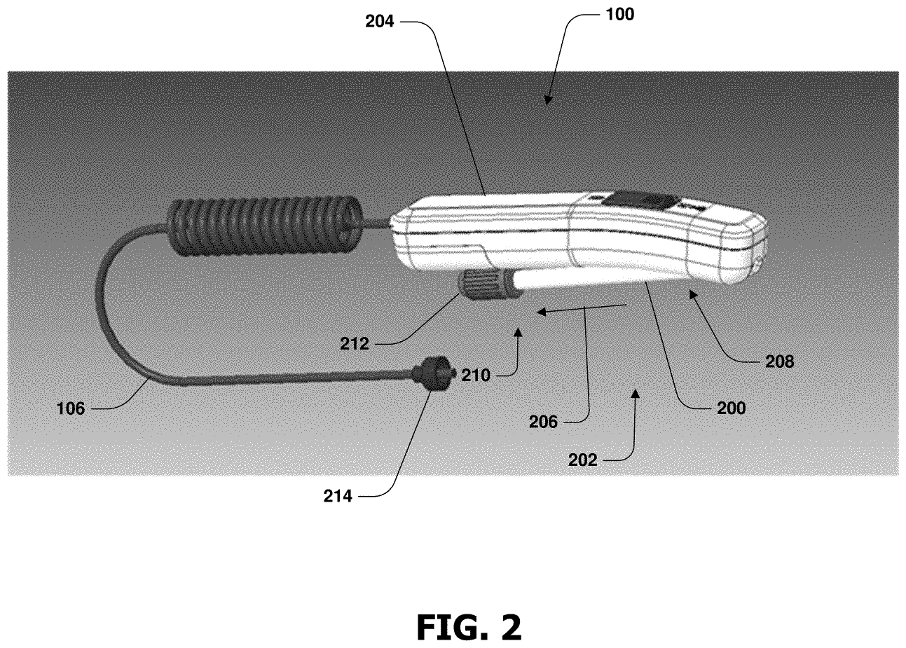

Referring to FIG. 2, the applicator 100 is illustrated with a foldable wand 200 in a closed position 202. The applicator includes a housing 204 generally defining the exterior of portions of the applicator 100. The foldable wand 200 extends in a first direction 206 between a first end 208 and a second end 210. A nozzle 212 is attached to the second end 210 of the wand 200. The nozzle 212 can be attached to the second end 210 of the wand 200 by any suitable means (e.g., a threaded connection). The nozzle 212 can be used to limit the amount of fluid that can be dispensed within a given time by controlling the area of an orifice defined by the nozzle 212. The orifice of the nozzle 212 can also define a fluid spray pattern as the fluid passes through the orifice and leaves the nozzle 212. In some examples, the orifice size and shape of the nozzle 212 cannot be altered as desired, however, a selection of multiple nozzles 212 can provide a range of fluid application volume per time and spray patterns as so desired. In other examples, the fluid spray pattern and fluid volume application may be specifically mandated such that nozzle 212 selection for particular applications may not be changed by the user.

The wand 200 can enable the user to have both a relatively long reach to apply the fluid to a desired application area (e.g., a surface to be disinfected) and enable the user to cover a relatively large area of application in a shorter time compared to applicators that may have nozzles relatively close to the user's hand. While not necessary, a threaded cap 214 can be located at one end of the first conduit 106 to secure the applicator 100 to the fluid reservoir 104 (shown in FIG. 1).

The first conduit 106 can be configured to deliver the fluid from the fluid reservoir 104 to the applicator 100. An application of a partial vacuum to the first conduit 106 tends to draw fluid from the fluid reservoir 104 to the applicator 100. Any suitable size or type of fluid reservoir 104 can be used with the present disclosure. Examples of fluid reservoirs can include refillable bottles and bulk containers that can be carried with a first hand while the user carries the applicator 100 with a second hand. In some examples, the first conduit 106 is flexible, such as a flexible tube or a flexible hose.

In some examples, the housing 204 can be separated from the reservoir such that the only connection between the housing 204 and the fluid reservoir 104 is the first conduit 106. This arrangement can allow the user to freely move the housing 204 relative to the reservoir to apply the fluid to a relatively broad area with little or no movement of the reservoir. It is also contemplated that the housing 204 can be attached to the reservoir such that the housing 204 and the fluid reservoir 104 cannot be moved relative to one another.

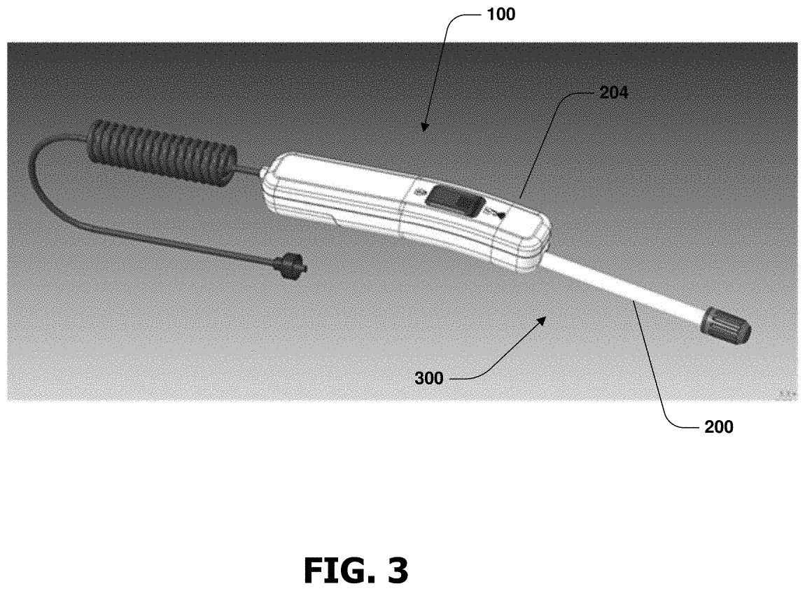

Referring to FIG. 3, the applicator 100 is illustrated with the foldable wand 200 in an open position 300. The wand 200 is rotatably coupled to the housing 204 between an open position 300 and the closed position 202 (shown in FIG. 2). In some examples, the wand 200 is rotatable through an angle of about 180° relative to the housing 204 when the wand 200 is rotated between the open position 300 and the closed position 202.

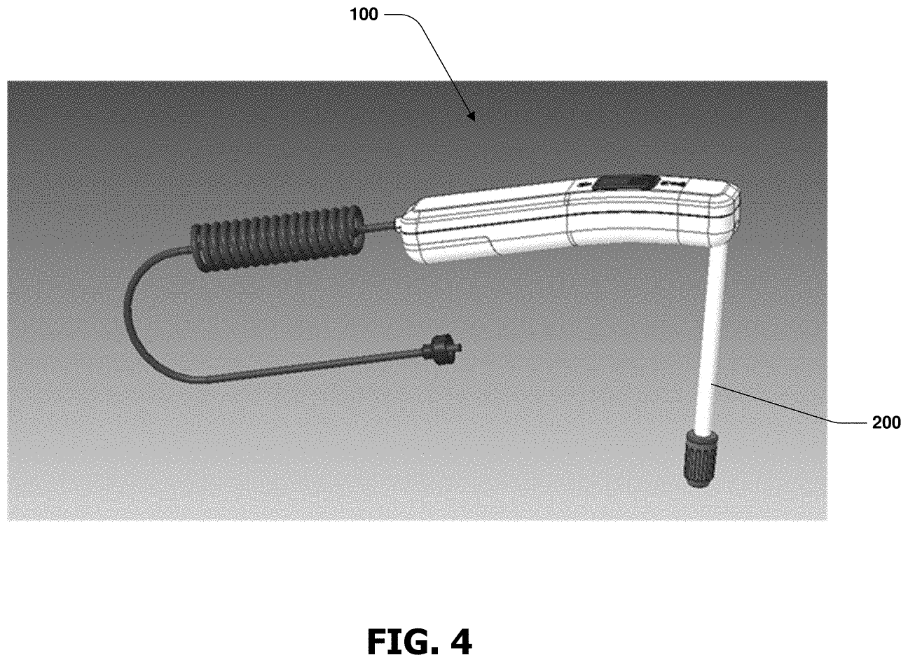

Referring to FIG. 4, an example applicator 100 with the foldable wand 200 in an intermediate position 400. The intermediate position 400 can be located at any suitable angle relative to the housing 204 between the open position 300 (shown in FIG. 3) and the closed position 202 (shown in FIG. 2).

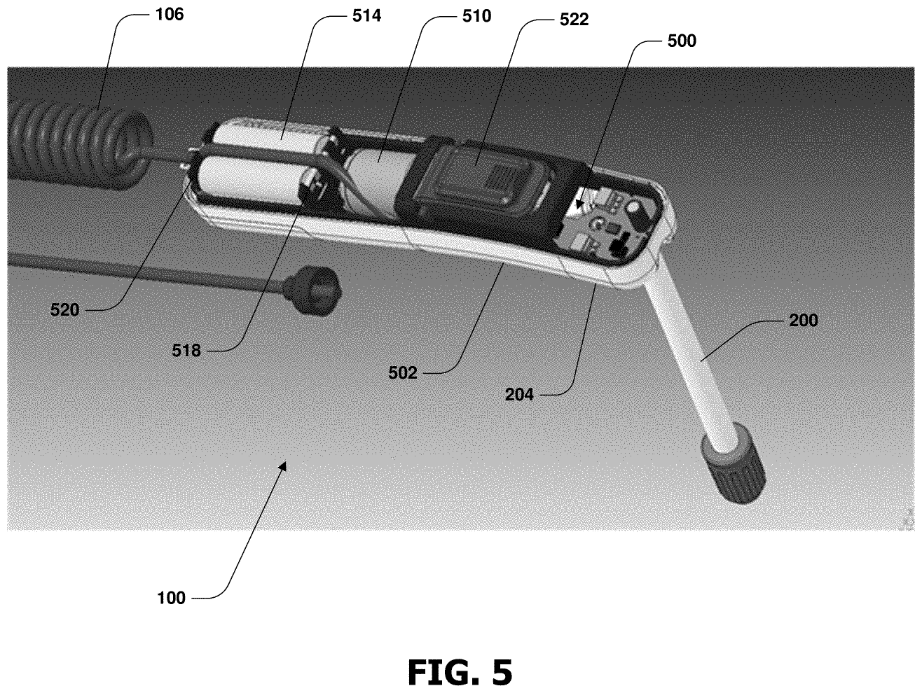

Referring to FIG. 5, a perspective view of an example applicator 100 is illustrated with an upper portion of the housing 204 removed for clarity. The housing 204 defines a hollow interior 500 that is configured to house various structures that will be described below. In some examples, the housing 204 can be divided into two or more sections that are attached together for ease of manufacturing and assembly. As shown, the housing 204 can include a first portion 502, and a second portion 504 that are shaped to fit the user's hand. The first portion 502 and the second portion 504 can each define approximately one-half of the housing 204. Each of the first portion 502 and the second portion 504 can be hollow so as to form the hollow interior 500. Any suitable attachment methods and structures can be used with the present disclosure to secure the first portion 502 to the second portion 504. Some examples include tab and slot attachments, snap fits, adhesive attachment, or threaded fasteners (e.g., screws). Of course, other combinations and numbers of housing portions can be placed together to form the entire housing 204.

As shown, the first conduit 106 can pass through an aperture in the housing 204 such that the fluid can be urged from the fluid reservoir 104 (shown in FIG. 1) to the hollow interior 500. An end 506 of the first conduit 106 can be attached to an inlet 508 of a fluid pump 510 disposed within the housing such that the fluid can be urged from the fluid reservoir 104 to the fluid pump 510. Any suitable fluid pump 510 can be used in conjunction with the present disclosure. The fluid pump 510 can be physically connected to and can be driven by an electric motor 512 that is disposed within the hollow interior 500. In turn, the electric motor 512 can be in electrical communication with a power source disposed within the hollow interior 500, such as a battery 514. Other power sources and numbers of power sources are also contemplated, for example, four (4) AA batteries, rechargeable batteries, a rechargeable capacitor, etc. The battery 514 provides electrical power to operate the electric motor 512.

Of course, in the provided example of four (4) AA batteries providing power to the electric motor 512, the housing 204 can also include battery terminals 518, a battery frame 520, and a circuit path (e.g., wiring) to provide an electrical circuit to operate the electric motor 512. In some examples, the battery frame 520 can be a portion of at least one of the first portion 502, the second portion 504, or the third portion 208.

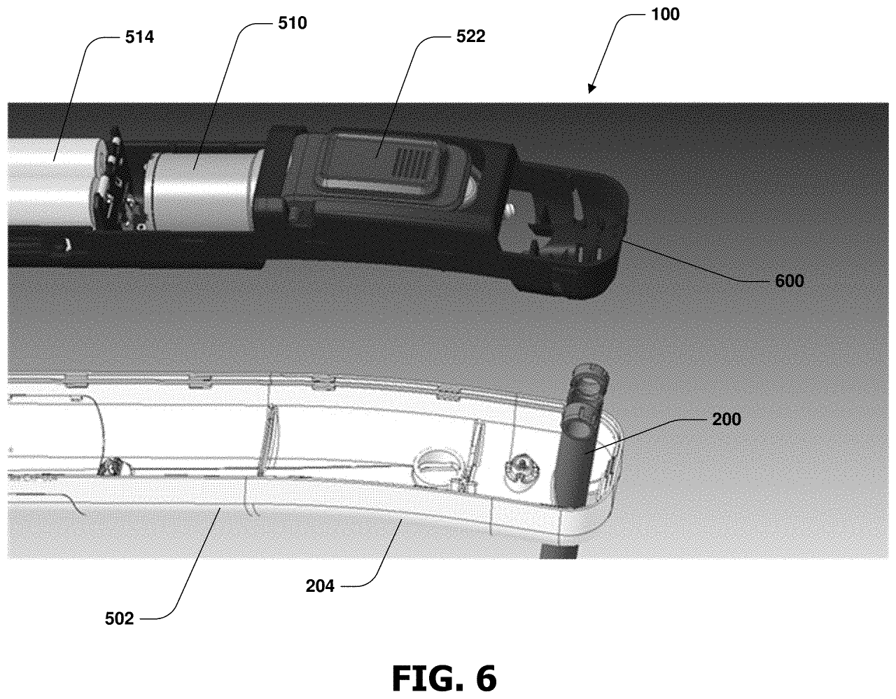

Referring to FIG. 6, a partially exploded view of the applicator 100 is illustrated. In some examples, a carriage 600 can be located within the housing 204 to organize the location of several internal components, some of which are described in relation to FIG. 5. The carriage 600 is shown providing mounting locations for the fluid pump 510, the battery 514, and the switch 522. The carriage 600 can be mounted to either one of the first portion 502 or the second portion 504 of the housing 204. The movable wand 200 is shown again in the intermediate position 400.

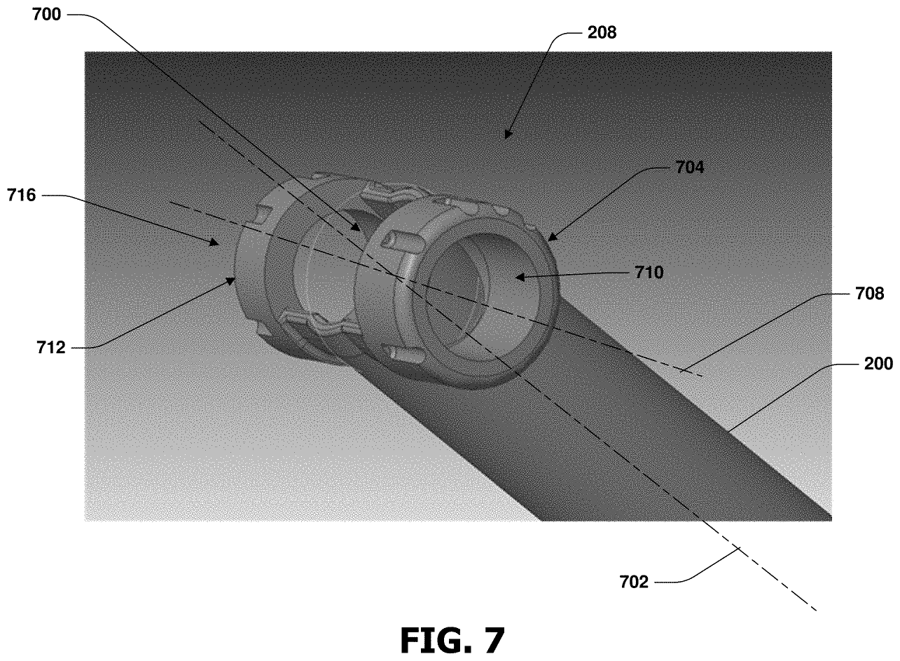

Referring to FIG. 7, a detail view of the first end 208 of the wand 200 is illustrated. The first end 208 can also be termed the knuckle of the wand 200. The wand 200 defines a duct 700 extending between the first end 208 of the wand 200 and the second end 210 (shown in FIG. 2) of the wand 200. For reference, the arrow labeled 700 points along (e.g., parallel to) the axis 702 of the duct 700. The duct 700 is configured to enable a second conduit to pass from the first end 208 to the second end 210 in a first direction, e.g., parallel to the axis 702.

The wand 200 includes a curved surface 704 that cooperates with at least one of a housing curved surface 706 (shown in FIG. 21) or a housing curved edge enabling the wand 200 to move (e.g., rotate) between the open position 300 and the closed position 202. In some examples, the curved surface 704 is cylindrical and is centered about an axis 708 which extends along a second direction. In some examples the second direction is non-parallel relative to the first direction. In some examples, the second direction is perpendicular to the first direction. The curved surface 704 can also define an aperture 710 that is configured to enable the second conduit to enter the wand 200 such that the conduit extends in a second direction non-parallel to the first direction to enter the first end 208.

The wand 200 can also include a second curved surface 712 that cooperates with at least one of a housing second curved surface 714 (shown in FIG. 21) or a housing curved edge enabling the wand 200 to move (e.g., rotate) between the open position 300 and the closed position 202. In some examples, the second curved surface 712 is cylindrical and is centered about the axis 708 which extends along the second direction. In some examples the second direction is oblique relative to the first direction. In some examples, the second direction is perpendicular to the first direction. The second curved surface 712 can also define a second aperture 716 that is configured to enable the second conduit to enter the wand 200 such that the conduit extends in a second direction non-parallel to the first direction to enter the first end 208. In some examples, the curved surface 704 and the second curved surface 712 are symmetrical about a fold axis 708 about which the wand 200 rotates between the open position and the closed position.

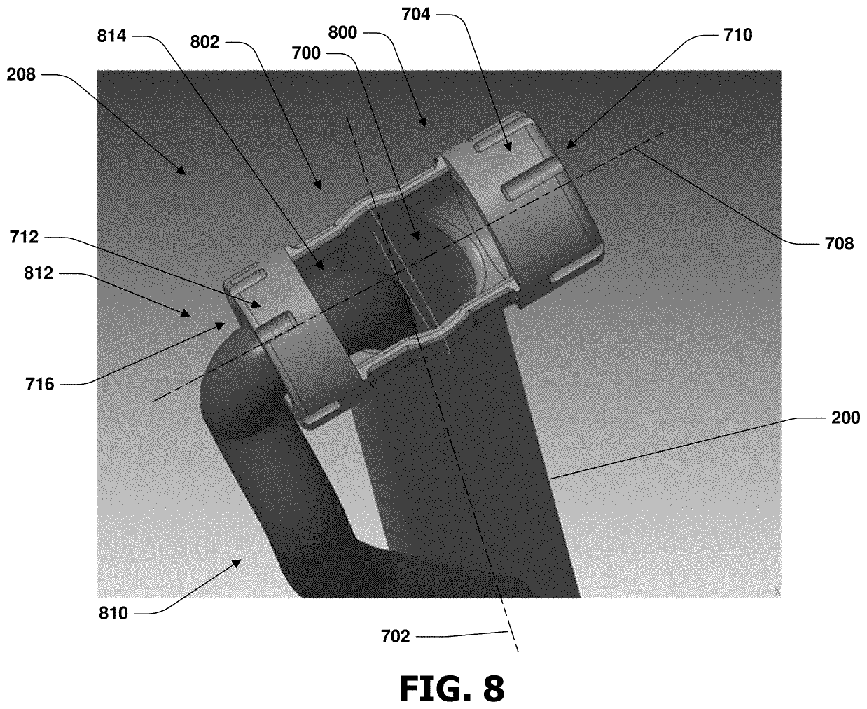

Referring to FIG. 8, a detail view of the first end 208 or the knuckle of the wand 200 is illustrated. The applicator of claim 3, wherein the curved surface 704 of the wand 200 is located on a first side 800 of a wand central axis 702 that extends in the first direction, and the second curved surface 712 of the wand 200 is located on a second side 802 of the wand central axis 702. As previously described, the wand 200 is rotatably coupled to the housing 204 between the open position 300 and the closed position 202. In some examples, the wand 200 is rotatable through an angle of about 180° relative to the housing 204.

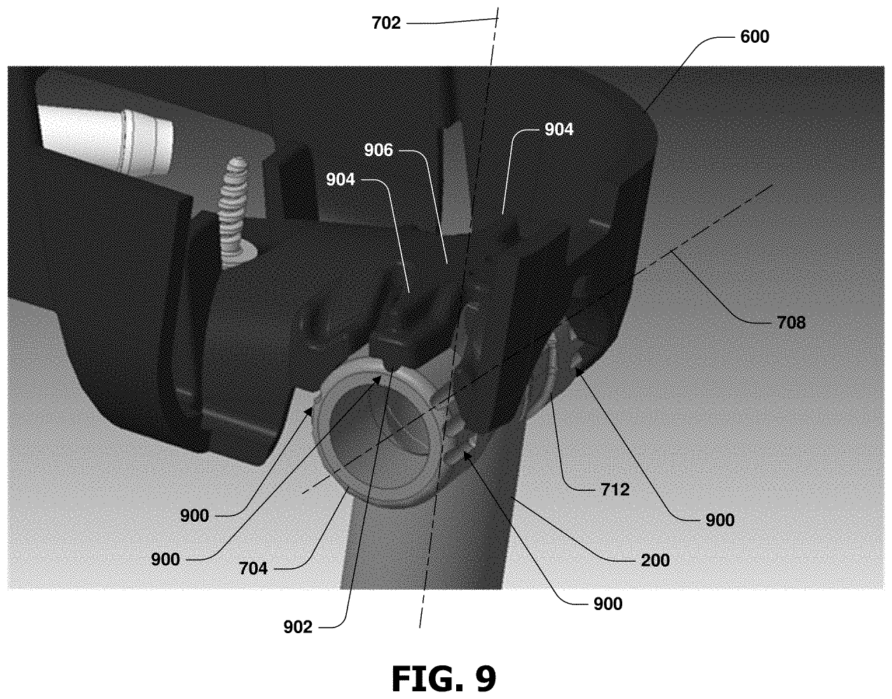

Referring to FIG. 9, a detail view of the applicator 100 is illustrated to show the cooperation of the wand 200 and a detent feature of at least one of the carriage 600 or the housing 204. In the shown example, the curved surface 704 defines a depression 900 that cooperates with a protrusion 902 or tab attached to the carriage 600 or the housing 204 to selectively locate the wand 200 in at least one of the open position 300, the closed position 202, or a position 400 between the open position 300 and the closed position 202. In some examples, a plurality of depressions 900 are defined radially around the curved surface 704. In some examples, a plurality of depressions 900 are spaced from one another to provide selective stops for the wand 200 at particular angles (e.g., 180°, 0°, 90°, 45°, etc.). These angles may align with particular wand 200 angular positions that provide benefit to the user.

The carriage 600 includes an arm 904 projecting in a cantilever fashion from a central support 906. The arm 904 can be constructed of material providing a spring force that urges the protrusion 902 into the depression 900 as rotation of the curved surface 704 moves the depression 900 into alignment with the protrusion 902. Once aligned, the spring force of the arm 902 urges the protrusion 902 into the depression 900 to provide a tactile or haptic indication to the user that the wand 200 is at a desired angle. The interaction of the protrusion 902 and the depression 900 additionally requires greater force to rotate the wand 200 to both rotate the wand 200 and urge the arm 902 upwards (e.g., away from the curved surface 704) to remove the protrusion 902 from the depression 900. Once free from the depression, the protrusion 902 can provide relatively low resistance to further rotation of the wand 200.

Similarly, the second curved surface 712 defines a depression 900 that cooperates with a protrusion 902 attached to the carriage 600 or the housing 204 to selectively locate the wand 200 in at least one of the open position 300, the closed position 202, or a position 400 between the open position 300 and the closed position 202. The depressions 900 defined by the second curved surface 712 can be radially located about the second curved surface 712 to match the spacing of depressions 900 defined by the curved surface 704. It is worthy of note that the described design provides support for the wand on two sides of the wand 200 (e.g., both sides of the wand central axis 702.

As with the first curved surface 704, the carriage 600 includes an arm 904 projecting in a cantilever fashion from a central support 906. The arm 904 can be constructed of material providing a spring force that urges the protrusion 902 into the depression 900 as rotation of the second curved surface 712 moves the depression 900 into alignment with the protrusion 902. Once aligned, the spring force of the arm 902 urges the protrusion 902 into the depression 900 to provide a tactile or haptic indication to the user that the wand 200 is at a desired angle. The interaction of the protrusion 902 and the depression 900 additionally requires greater force to rotate the wand 200 to both rotate the wand 200 and urge the arm 902 upwards (e.g., away from the second curved surface 712) to remove the protrusion 902 from the depression 900. Once free from the depression, the protrusion 902 can provide relatively low resistance to further rotation of the wand 200.

It is also worthy of note that the second direction can be parallel to the axis 708. In some examples, the second direction is colinear with the axis 708. As one can see from the figures, the foldable wand 200 is selectively rotatable about the axis 708 as a user urges angular rotation of the wand 200. As such, the axis 708 can be termed the fold axis.

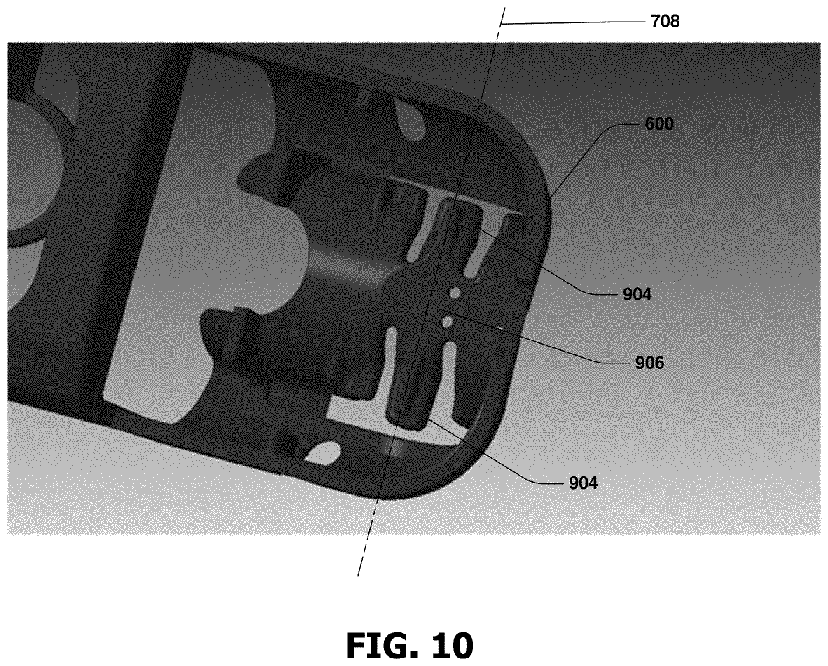

Referring to FIG. 10, a top view detail of the carriage 600 is illustrated. As shown, the arms 904 are cantilevered away from the central support 906. The arms can be centered about the axis 708 such that the protrusion 902 (not shown in FIG. 10) is urged toward the axis 708 without a perpendicular distance between a force applied by the protrusion 902 and the axis 708. This can help eliminate a moment arm force that may be applied to the curved surface 704 or the second curved surface 712.

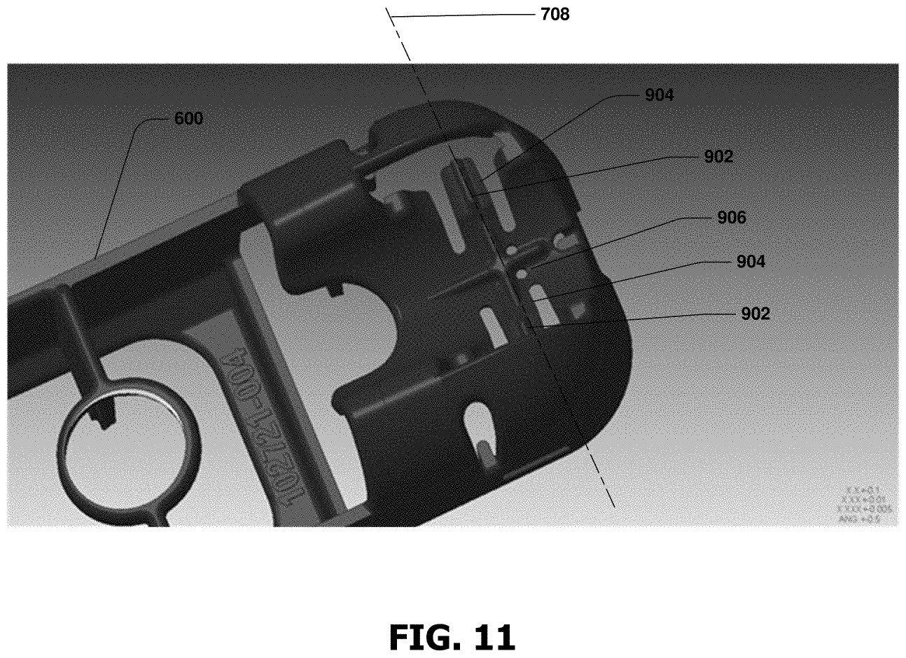

Referring to FIG. 11, a bottom view detail of the carriage 600 is illustrated. This view shows the protrusion 902 on each arm 904 to be centrally located and in-line with the axis 708 (e.g., the fold axis).

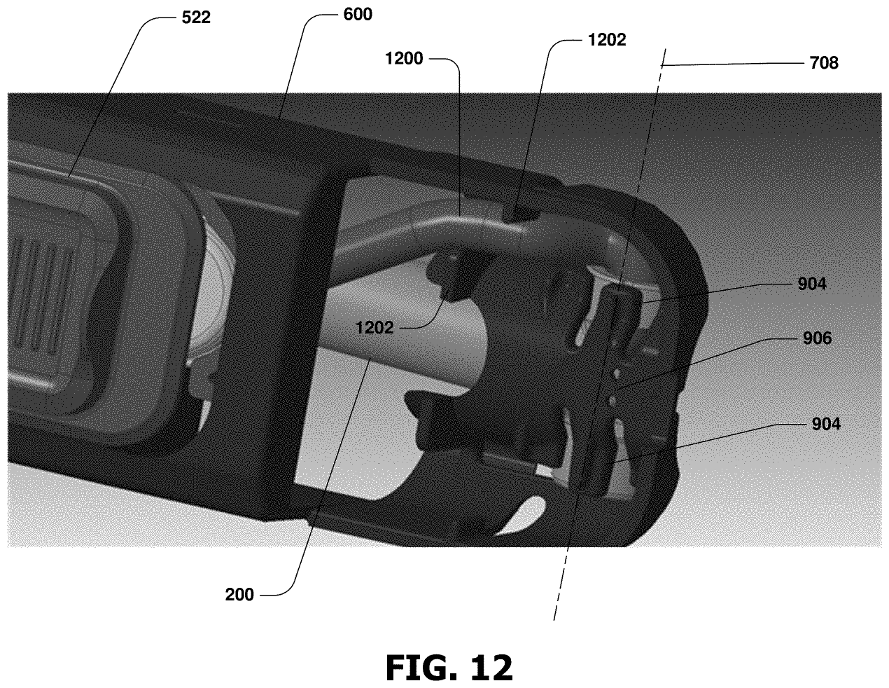

Referring to FIG. 12, a top view detail of the carriage 600 is illustrated. As shown, a second conduit 1200 is shown extending along an interior wall of the carriage 600. While not shown in FIG. 12, the fluid pump 510 includes an outlet, and the fluid outlet is connected to the second conduit 1200 to provide a path for the fluid to be applied or dispensed from the fluid pump 510 to the nozzle 212 (not shown in FIG. 12). In some examples, the second conduit 1200 is attached to the nozzle 212 such that there is only a single wetted fluid delivery path component between the fluid pump 510 and the nozzle 212. The wand 200 is shown in the closed position 202 in FIG. 12. In some examples, the carriage 600 includes posts 1202 configured to eliminate movement of the second conduit 1200 during rotation of the wand 200.

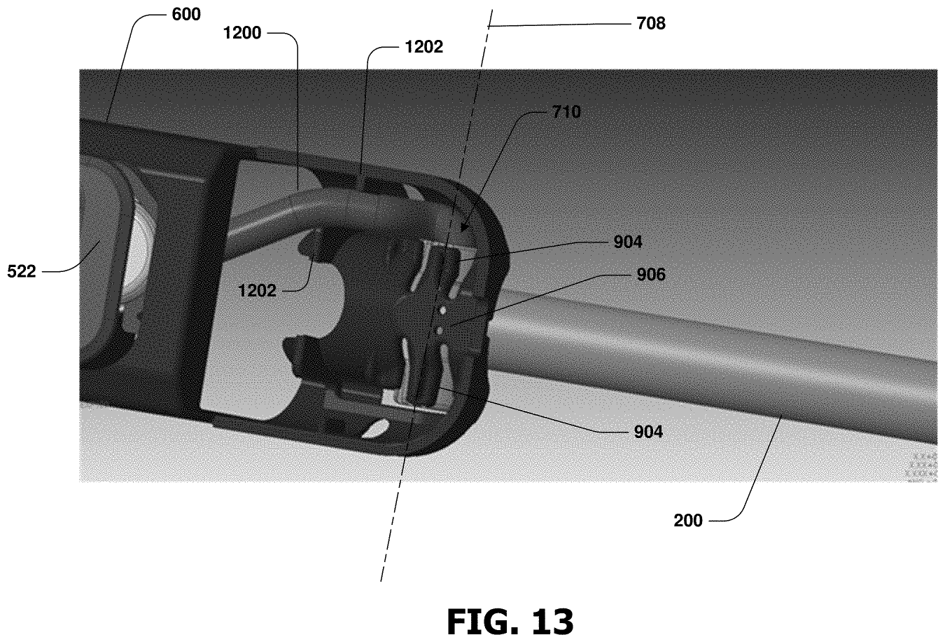

Referring to FIG. 13, a top view detail of the carriage 600 is illustrated. The wand 200 is shown in the open position 300, rotated away from the closed position 202 of FIG. 12. The second conduit 1200 has not appreciably moved locations within the carriage 600 framework. It is worthy of note that regardless of whether the wand 200 is in the open position 300, the closed position 202, or in any intermediate position 400 between the open position 300 and the closed position 202, the second conduit 1200 extends from the fluid pump 510 to the first end 208 of the wand 200 such that the fluid flows in the first direction 206 en-route to being dispensed from the second end 210 of the wand 200.

Additionally, the second conduit 1200 remains in the aperture 710 when the wand 200 is in the open position 300, the closed position 202, and any intermediate position 400 between the open position 300 and the closed position 202. In some examples, the second conduit 1200 flexes through at least 90° of rotation when the wand 200 rotates between the open position 300 and the closed position 202.

Furthermore, at least one portion of the second conduit 1200 (e.g., as the second conduit enters the aperture 710) is colinear with the fold axis 708 about which the wand 200 rotates between the open position 300 and the closed position 202. Because this portion of the second conduit 1200 is basically colinear with the fold axis 708, this portion of the second conduit 1200 twists about its own axis when the wand 200 rotates between the open position 300 and the closed position 202. This rotation helps eliminate movement of the second conduit 1200 within the housing 204. This lack of movement can be beneficial, as the second conduit 1200 is less likely to be pinched by moving objects within the housing 204. This arrangement can also help reduce the required volume of the hollow interior 500 within the housing 204.

Returning to FIG. 8, when the conduit axis (at the point of entry to aperture 710 or second aperture 716) is colinear with the fold axis 708, a path that the second conduit 1200 traverses does not lengthen or shorten as a result of the wand 200 being rotated relative to the housing 204. The second conduit 1200 is constrained to twist about the fold axis 708 with one end passing into the wand 200, and the other end held in the housing 204. This differs from known second conduit apparatus where the conduit axis is not colinear with the fold axis, and the second conduit takes up slack, twists, etc. built into the applicator in order to maintain the connection between the pump and the wand.

The path that the second conduit 1200 traverses does not lengthen or shorten as a result of the wand 200 being rotated relative to the housing 204. In order to illustrate this constant path length, a first portion 810 of the second conduit 1200 is disposed in the housing 204. A second portion 812 of the second conduit 1200 is disposed in the curved portion 712 of the wand 200. Finally, a third portion 814 of the second conduit 1200 is disposed in the duct 700 of the wand 200. The second portion 812 is located between the first portion 810 and the third portion 814.

As previously discussed and shown, the wand 200 is rotatable from a first position relative to the housing 204 to a second position relative to the housing 204 and positions in between the first position and the second position. When in the first position, a conduit path of the second conduit 1200 from the first portion 810 to the third portion 814 has a first length. Additionally, when in the second position, the conduit path from the first portion 810 to the third portion 814 has a second length, and the first length is equal to the second length. This is because as the wand 200 is rotated between the first position and the second position, the second conduit 1200, in the second portion 812 location (e.g., within the linear portion of the curved portion 704 or 712) rotates about its conduit axis colinear with the fold axis 708 rather than the second portion 812 rotating about its conduit axis when it is not colinear with the fold axis 708. Previously known apparatus appear to necessarily need to bend, kink, or otherwise take up slack in the conduit in order for the conduit to rotate with its respective wand. This is because the conduit does not pass through the fold axis or is not colinear with the fold axis of the wand.

In order to help maintain the position of the first portion 810 of the second conduit 1200 in a single position, some examples of the applicator 100 include two posts 1202 extending from an interior surface of the housing 204 and the first portion 810 of the second conduit 1200 is located between the two posts 1202. In this way, the first post 1202 provides a physical interference to inhibit the first portion 810 of the second conduit 1200 from rotating about the fold axis 708. Even while the first portion 810 of the second conduit 1200 is physically prevented from rotating about the fold axis 708, the second portion 812 does rotate about the fold axis 708, however this rotation results only in a twisting action upon the second portion 812 and does not increase or decrease the length of the path of the second conduit 1200. As shown, the posts 1202 can be located on either side of the first portion 810 as seen in FIG. 12.

It is to be appreciated that the described mechanism allows the output sprayer tube to exit at the mechanical hinge centerline. Because the conduit is fixedly attached at a first end at the valve outlet and at a second end at the nozzle, the conduit is able to rotate about its own axis with the twisting force over the length of the conduit. Additionally, the conduit can enter the knuckle and/or the wand at the axis of rotation of the wand. Alternatively, a centerline of the conduit can be colinear with an axis of rotation of the wand and/or the knuckle. The present disclosure also enables the conduit to exit the housing without pinching the tube as may happen in previously known sprayers or applicators, saving space at the pivot/knuckle exit area. This also allows room for a ratchet mechanism for the pivot knuckle.

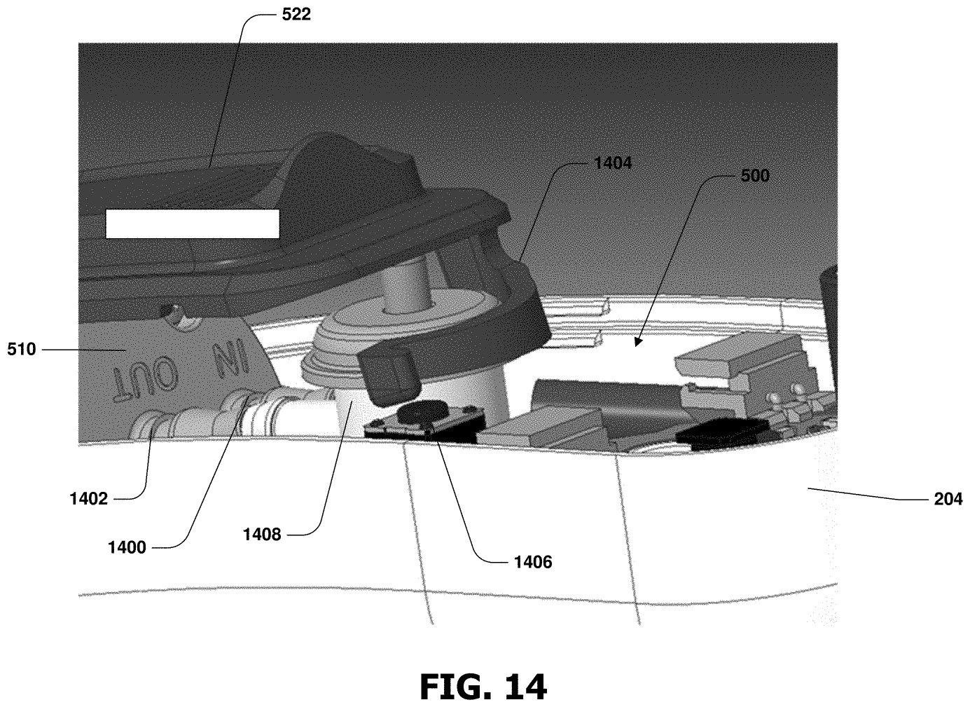

Referring to FIG. 14, a perspective view of the hollow interior 500 of the applicator 100 is illustrated having a portion of the housing 204 and the carriage 600 removed for clarity. Within the hollow interior 500, the fluid pump 510 has a labeled pump inlet 1400 and a pump outlet 1402. The second conduit 1200 is shown attached to the fluid pump 510 pump outlet 1402. As shown, the switch 522 can include a switch arm 1404 such that the switch 522 can activate both the activation switch 1406 for the fluid pump 510 and a valve 1408. The valve 1408 can help prevent undesired drips of fluid from the nozzle 212.

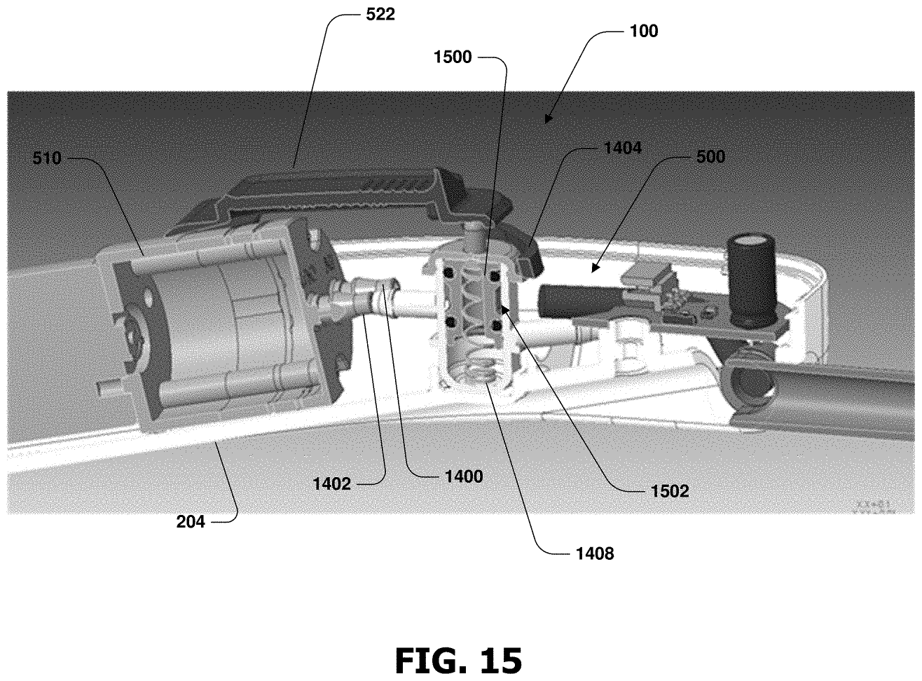

Referring to FIG. 15, a partial cross-section view of the applicator 100 is illustrated. Valve 1408 can include a spring-operated normally closed valve. When the trigger 522 is depressed to activate the fluid pump 510, the center core 1500 of the valve 1408 will move downward such that an annular passage 1502 is placed in fluid communication with both a valve inlet and a valve outlet.

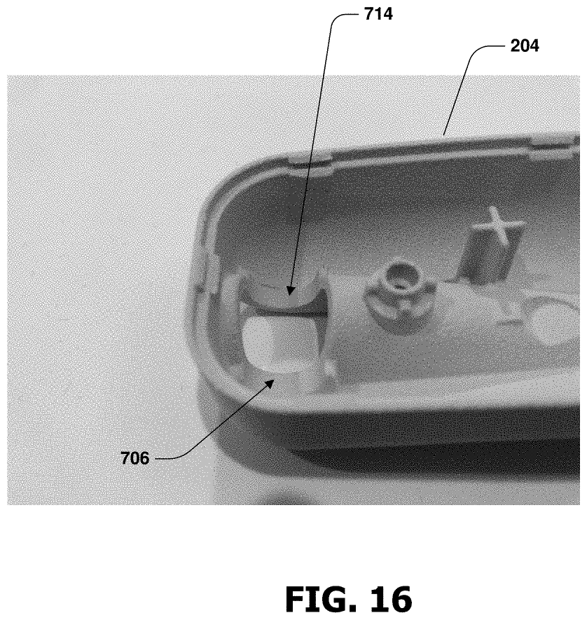

Referring to FIG. 16, a section of the housing 204 is illustrated to show the housing curved surface 706 and the housing second curved surface 714. The curved surface 704 and the second curved surface 712 cooperate with the housing curved surface 706 and the housing second curved surface 714 to enable rotation of the wand 200.

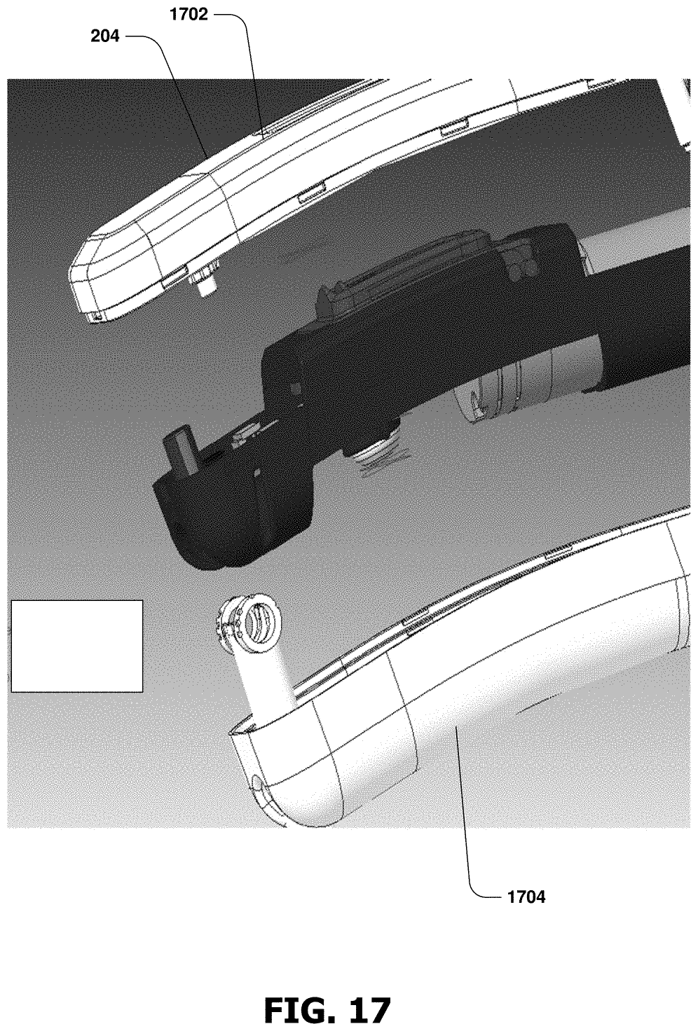

Referring to FIG. 17, an example two-piece housing 204 is illustrated. A top housing piece 1702 can be mated with and secured to a bottom housing piece 1704 to construct a single housing. Other numbers of housing pieces are also contemplated.

Several of the figures show the wand 200 in the second position which is extended away from the housing 204, or an open position. As shown, the first position can include the wand 106 located essentially parallel to a bottom surface of the applicator 100, or a closed position. Some figures also show the housing 204 defining a slot through which the wand 200 is able to rotate. When the user desires to use the applicator 100, the user places a force on the wand to urge the wand to rotate about the fold axis 708 to extend away from the housing 204. In some examples, the wand 200 can rotate about 200° from the first position to the second position. In some examples, the wand 106 can rotate about 190° from the first position to the second position. In still further examples, the wand 106 can rotate about 180° from the first position to the second position. Other rotational ranges are also contemplated.

As shown in the figures, an applicator for dispensing a fluid includes a housing. In some examples, a pump is disposed within the housing. Additionally, a wand extends in a first direction between a first end and of the wand and a second end of the wand. The wand is rotatably coupled to the housing between an open position and a closed position.

Regardless of whether the wand is in the open position, the closed position, or in an intermediate position between the open position and the closed position, a conduit extends from the pump to the first end of the wand. The fluid flows in the first direction en-route to being dispensed from the second end of the wand.

The wand defines an aperture through which the conduit enters the first end of the wand such that the conduit extends in a second direction non-parallel to the first direction to enter the first end. Also, the conduit remains in the aperture when the wand is in the open position, the closed position, and any intermediate position between the open position and the closed position.

The wand comprises a curved surface which defines the aperture, and the curved surface cooperates with at least one of a curved surface or a curved edge of the housing to move between the open position and the closed position.

In some examples, the wand comprises a second curved surface defining a second aperture, and the second curved surface cooperates with at least one of a second curved surface or a second curved edge of the housings to move between the open position and the closed position.

In some examples, the curved surface of the wand is located on a first side of a wand central axis and the second curved surface of the wand is located on a second side of the wand central axis.

In some examples, the conduit enters the first end of the wand through the second aperture, instead of the aperture, such that the conduit extends in the second direction non-parallel to the first direction, and the conduit remains in the second aperture when the wand is in the open position, the closed position, and between the open position and the closed position.

As previously discussed and shown, the wand 106 is rotatable from a first position relative to the housing 204 to a second position relative to the housing 204 and positions in between the first position and the second position. When in the first position, a conduit path of the conduit from the first portion 1300 to the third portion 1304 has a first length. Additionally, when in the second position, the conduit path from the first portion 1300 to the third portion 1304 has a second length, and the first length is equal to the second length. This is because as the wand 106 is rotated between the first position and the second position, the second conduit 302, in the second portion 1302 location (e.g., within the linear portion 800 of the curved portion 702) rotates about its conduit central axis 1000 colinear with the fold axis 404 rather than the second portion rotates about its conduit central axis 1000 when it is not colinear with the fold axis 404. Previously known apparatus necessarily need to bend, kink, or otherwise take up slack in the conduit in order for the conduit to rotate with its respective wand. This is because the conduit does not pass through the fold axis or is not colinear with the fold axis of the wand.

In order to help maintain the position of the first portion 1300 of the second conduit 302 in a single position, some examples include a first bracket 1306 cooperating with the first portion 1300 of the second conduit 302. In some examples, cooperating with the first portion 1300 means being, at times, in contact with the second conduit 302. In some examples, the first bracket 1306 includes two posts 1308 extending from an interior surface of the housing 204 and the first portion 1300 of the second conduit 302 is located between the two posts 1308. In this way, the first bracket 1306 provides a physical interference to inhibit the first portion 1300 of the second conduit 302 from rotating about the fold axis 404. Even while the first portion 1300 of the second conduit 302 is physically prevented from rotating about the fold axis 404, the second portion 1302 does rotate about the fold axis 404, however this rotation results only in a twisting action upon the second portion 1302 and does not increase or decrease the length of the path of the second conduit 302. As shown, the posts 1308 can be located on either side of the first portion 1300.

It is to be appreciated that the described mechanism allows the output sprayer tube to exit at the mechanical hinge centerline. Because the conduit is fixedly attached at a first end at the valve outlet and at a second end at the nozzle, the conduit is able to rotate about its own axis with the twisting force over the length of the conduit. Additionally, the conduit can enter the knuckle and/or the wand at the axis of rotation of the wand. Alternatively, a centerline of the conduit can be colinear with an axis of rotation of the wand and/or the knuckle. The present disclosure also enables the conduit to exit the housing without pinching the tube as may happen in previously known sprayers or applicators, saving space at the pivot/knuckle exit area. This also allows room for a ratchet mechanism for the pivot knuckle

Several benefits can be derived from the structures and methods described herein. For example, the colinear fold axis and conduit central axis can reduce and or eliminate kinks and undesired bends within the second conduit. Additionally, the design aspect of the presently disclosed device can be simplified by eliminating the requirement for space within the hollow interior of the housing needed to accommodate extra length and changing pathways of the second conduit.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or.” In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes,” “having,” “has,” “with,” and/or variants thereof are used in either the detailed description or the claims, such terms are intended to be inclusive in a manner similar to the term “comprising.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An applicator for dispensing a fluid, comprising:
a housing;
a pump disposed within the housing; and
a wand extending in a first direction between a first end and a second end, the wand rotatably coupled to the housing between an open position and a closed position, wherein:
regardless of whether the wand is in the open position, the closed position, or between the open position and the closed position, a conduit extends from the pump to the first end of the wand such that the fluid flows in the first direction en-route to being dispensed from the second end of the wand,
the wand defines an aperture through which the conduit enters the first end of the wand such that the conduit extends in a second direction non-parallel to the first direction to enter the first end, and
the conduit remains in the aperture when the wand is in the open position, the closed position, and between the open position and the closed position.

2. The applicator of claim 1, wherein:
the wand comprises a curved surface which defines the aperture, and
the curved surface cooperates with at least one of a housing curved surface or a housing curved edge to move between the open position and the closed position.

3. The applicator of claim 2, wherein:
the wand comprises a second curved surface defining a second aperture, and
the second curved surface cooperates with at least one of a housing second curved surface or a housing second curved edge to move between the open position and the closed position.

4. The applicator of claim 3, wherein the curved surface of the wand is located on a first side of a wand central axis that extends in the first direction, and the second curved surface of the wand is located on a second side of the wand central axis.

5. The applicator of claim 3, wherein the conduit flexes through at least 90° of rotation when the wand rotates between the open position and the closed position.

6. The applicator of claim 1, comprising:
a nozzle attached to the second end of the wand, wherein the conduit extends between the pump and the nozzle to deliver the fluid from the pump to the nozzle at the second end of the wand.

7. The applicator of claim 1, wherein the wand is rotatable through an angle of about 180° relative to the housing.

8. The applicator of claim 1, wherein the second direction is parallel to a fold axis about which the wand rotates between the open position and the closed position.

9. The applicator of claim 1, wherein the conduit is colinear with a fold axis about which the wand rotates between the open position and the closed position.

10. The applicator of claim 1, wherein the first direction is perpendicular to the second direction.

11. An applicator for dispensing a fluid, comprising:
a housing;
a pump disposed within the housing; and
a wand extending in a first direction between a first end and a second end, the wand rotatably coupled to the housing between an open position and a closed position, the wand defining a duct extending between the first end and the second end, the wand comprising:
a curved surface located at the first end, the curved surface defining an aperture; and
a conduit extending from the pump to the first end of the wand such that the fluid flows in the first direction en-route to being dispensed from the second end of the wand, the conduit comprising:
a first portion disposed in the housing,
a second portion disposed in the curved surface, and
a third portion disposed in the duct, wherein:
the conduit passes through the aperture to enter the first end of the wand such that the conduit extends in a second direction non-parallel to the first direction to enter the first end of the wand;
the wand is rotatable from a first position relative to the housing to a second position relative to the housing,
when in the first position, a conduit path of the conduit from the first portion to the third portion has a first length,
when in the second position, the conduit path from the first portion to the third portion has a second length, and
the first length is equal to the second length.

12. The applicator of claim 11, wherein:
the curved surface cooperates with at least one of a housing curved surface or a housing curved edge to move between the open position and the closed position,
the wand comprises a second curved surface defining a second aperture, and
the second curved surface cooperates with at least one of a housing second curved surface or a housing second curved edge to move between the open position and the closed position.

13. The applicator of claim 12, wherein the curved surface of the wand is located on a first side of a wand central axis and the second curved surface of the wand is located on a second side of the wand central axis.

14. The applicator of claim 12, wherein the curved surface and the second curved surface are symmetrical about a fold axis about which the wand rotates between the open position and the closed position.

15. The applicator of claim 11, wherein the curved surface defines a depression that cooperates with a protrusion attached to the housing to selectively locate the wand in at least one of the open position, the closed position, or a position between the open position and the closed position.

16. An applicator for dispensing a fluid, comprising:
a housing;
a pump disposed within the housing; and
a wand extending in a first direction between a first end and a second end, the wand rotatably coupled to the housing between an open position and a closed position, the wand defining a duct extending between the first end and the second end, the wand comprising:
a curved surface located at the first end, the curved surface defining an aperture; and
a conduit extending from the pump to the first end of the wand such that the fluid flows in the first direction en-route to being dispensed from the second end of the wand, the conduit comprising:
a first portion disposed in the housing,
a second portion disposed in the curved surface, and
a third portion disposed in the duct, wherein:
the conduit passes through the aperture to enter the first end of the wand such that the conduit extends in a second direction non-parallel to the first direction to enter the first end of the wand,
the wand is rotatable from a first position relative to the housing to a second position relative to the housing, and
the second portion of the conduit rotates about a conduit central axis as the wand is rotated from a first position relative to the housing to a second position relative to the housing.

17. The applicator of claim 16, comprising:
a nozzle attached to the second end of the wand, wherein the conduit extends between the pump and the nozzle to deliver the fluid from the pump to the nozzle at the second end of the wand.

18. The applicator of claim 16, wherein the wand is rotatable through an angle of about 180° relative to the housing.

19. The applicator of claim 16, wherein:
the wand comprises a curved surface which defines the aperture, and
the curved surface cooperates with at least one of a housing curved surface or a housing curved edge to move between the open position and the closed position.

20. The applicator of claim 19, wherein:
the wand comprises a second curved surface defining a second aperture, and
the second curved surface cooperates with at least one of a housing second curved surface or a housing second curved edge to move between the open position and the closed position.
